(19) United States
(12) Patent Application Publication
(10) Pub. No.: US 2007/0297334 A1
(43) Pub. Date: Dec. 27, 2007

(54) Method and system for network protocol offloading

(76) Inventor: Fong Pong, Mountain View, CA (US)

Correspondence Address: MCANDREWS HELD & MALLOY, LTD, 500 WEST MADISON STREET, SUITE 3400, CHICAGO, IL, 60661, US

(21) Appl. No.: 11/475,571

(22) Filed: Jun. 21, 2006

(51) Int. Cl. H04J 1/16; H04L 12/56

(52) U.S. Cl. 370/235; 370/389

(57) ABSTRACT

Aspects of a method and system for network protocol offloading are provided. A path may be established between a host socket and an offloaded socket in a TOE for offloading a TCP connection to the TOE. Offload functions associated with extensions to the host socket may enable TCP offload and IP layer bypass extensions in a network device driver for generating the offload path. In this regard, a flag in the host socket extensions may indicate when connection offloading is to occur. The offload path may be established after the connection is established via a native stack in the host or after a listening socket is offloaded to the TOE for establishing the connection. Data for retransmission for the offloaded connection may be stored in the host or in the TOE. The offloaded connection may be terminated in the TOE or may be migrated to the host for termination.

### CROSS-REFERENCE TO RELATED APPLICATIONS/INCORPORATION BY REFERENCE

[Not Applicable]

### FIELD OF THE INVENTION

Certain embodiments of the invention relate to handling of network connections. More specifically, certain embodiments of the invention relate to a method and system for network protocol offloading.

### BACKGROUND OF THE INVENTION

The initial development of transmission control protocol (TCP) was based on networking and processing capabilities that were then currently available. As a result, various fundamental assumptions regarding its operation were prefaced on networking and processor technologies that existed at that time. Among the assumptions on which TCP was prefaced includes the scarcity and high cost of bandwidth and the partially limitless processing resources available by a host processor. With the advent of technologies such as Gigabit Ethernet (GbE), these fundamental assumptions have radically changed to the point where bandwidth is no longer as scarce and expensive and the host processing resources are now regarded as being limited rather than virtually infinite. In this regard, the bottleneck has shifted from the network bandwidth to the host processing bandwidth. Since host processing systems do more than merely providing faster network connections, shifting network resources to provide much faster network connections will do little to address the fundamental change in assumptions. Notably, shifting network resources to provide much faster network connections would occur at the expense of executing system applications, thereby resulting in degradation of system performance.

Although new networking architectures and protocols could be created to address the fundamental shift in assumptions, the new architectures and protocols would still have to provide support for current and legacy systems. Accordingly, solutions are required to address the shift in assumptions and to alleviate any bottlenecks that may result with host processing systems. A transmission control protocol/internet protocol (TCP/IP) offload engine (TOE) may be utilized to redistribute TCP processing from the host system onto specialized processors which may have suitable software for handling TCP processing. The TOEs may be configured to implement various TCP algorithms for handling faster network connections, thereby allowing host system processing resources to be allocated or reallocated to application processing.

In order to alleviate the consumption of host resources, a TCP connection can be offloaded from a host to a dedicated TCP/IP offload engine (TOE). Some of these host resources may include CPU cycles and subsystem memory bandwidth. During the offload process, TCP connection state information is offloaded from the host, for example from a host software stack, to the TOE. A TCP connection can be in any one of a plurality of states at a given time. To process the TCP connection, TCP software may be adapted to manage various TCP defined states. Being able to manage the various TCP defined states may require a high level of architectural complexity in the TOE.

In order to offload a TCP connection, the operating system (OS) executing in the host system may need to provide a manner of supporting protocol offload. Many current operating systems either do not provide TCP offloading capabilities or their architectures provide inefficient or limited TCP offloading capabilities. An approach that easily and/or efficiently enhances the TCP offloading capabilities of operating systems executing in a host system may enable much faster network connections by allowing the TOE to perform resource-intensive network processing operations.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for network protocol offloading, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system architecture that may be utilized for network protocol offloading, in connection with an embodiment of the invention.

FIG. 2 is a block diagram of an exemplary software architecture that may be utilized for network protocol offloading, in accordance with an embodiment of the invention.

FIG. 3 is a block diagram illustrating exemplary Unix/Linux native stack extension in the kernel space in FIG. 2 for network protocol offloading, in accordance with an embodiment of the invention.

FIG. 4A is a block diagram illustrating exemplary offloading of a TCP session by creating a plumbing channel or path via endpoint association, in accordance with an embodiment of the invention.

FIG. 4B is a block diagram illustrating exemplary endpoint association of multiple TCP sessions, in accordance with an embodiment of the invention.

FIG. 5 is a block diagram illustrating exemplary opening of a TCP connection via the native stack, in accordance with an embodiment of the invention.

FIG. 6 is a block diagram illustrating an exemplary offloading of a listening socket, in accordance with an embodiment of the invention.

FIG. 7 is a block diagram illustrating exemplary hooks on the native stack for packet send offload, in accordance with an embodiment of the invention.

FIG. 8A is a block diagram illustrating an exemplary system where the host handles retransmission by maintaining transmitted data in the host socket send queue, in accordance with an embodiment of the invention.

FIG. 8B is a block diagram illustrating an exemplary system where the TOE handles retransmission by maintaining transmitted data in the offload socket send queue until the data is acknowledged, in accordance with an embodiment of the invention.

FIG. 9 is a block diagram illustrating exemplary hooks on the native stack for packet receive, in accordance with an embodiment of the invention.

FIG. 10A is a block diagram illustrating exemplary active close connection termination, in accordance with an embodiment of the invention.

FIG. 10B is a block diagram illustrating exemplary passive close connection termination, in accordance with an embodiment of the invention.

FIG. 11 is a block diagram illustrating exemplary route management and offload of a route, in accordance with an embodiment of the invention.

### DETAILED DESCRIPTION OF THE INVENTION

Certain embodiments of the invention may be found in a method and system for network protocol offloading. Aspects of the invention may comprise establishing a path between a host socket and an offloaded socket in a TCP offload engine (TOE) for offloading a TCP connection to the TOE. Offload functions associated with extensions to the host socket may enable TCP offload and IP layer bypass extensions in a network device driver for generating the offload path. In this regard, a flag, for example, in the host socket extensions may indicate when connection offloading is to occur. The offload path may be establishing after the TCP connection is established via a native stack in the host or after a listening socket is offloaded to the TOE for establishing the connection. Data for retransmission for the offloaded connection may be stored in the host or in the TOE. The offloaded connection may be terminated in the TOE or may be migrated to the host for termination.

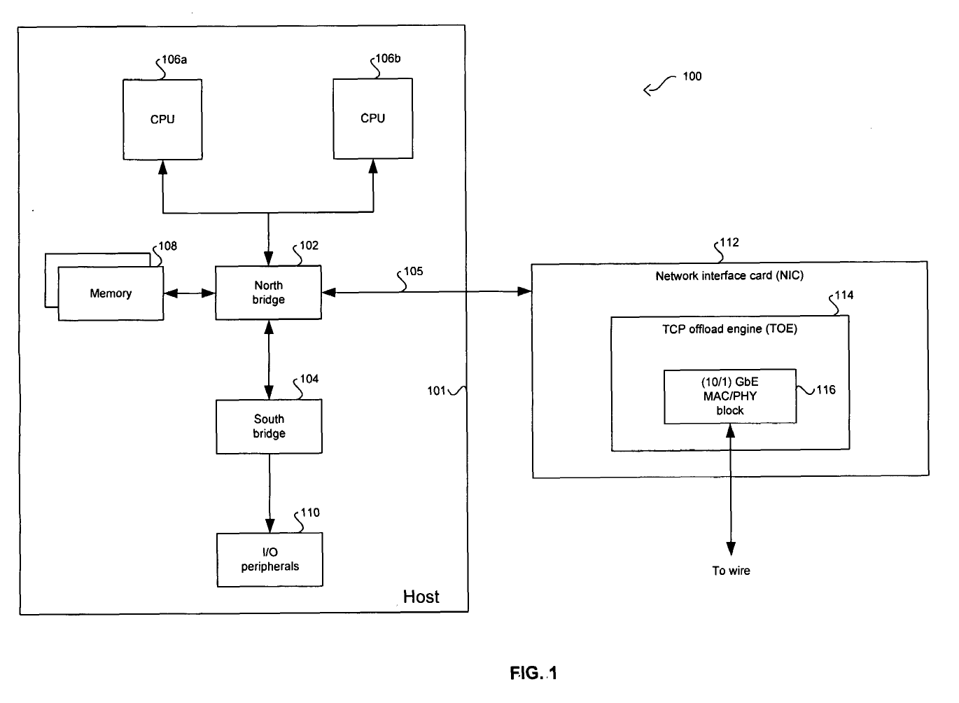

FIG. 1 is a block diagram of an exemplary system architecture that may be utilized for network protocol offloading, in connection with an embodiment of the invention. Referring to FIG. 1, there is shown a system 100 that may comprise a host 101 and a network interface card (NIC) 112. The host 101 may comprise a first central processing unit (CPU) 106a, a second CPU 106b, a north bridge 102, a memory 108, a south bridge 104, and input/output (I/O) peripherals 110. The NIC 112 may comprise a TOE 114. The TOE 114 may comprise a Gigabit Ethernet (GbE) medium access control (MAC) and physical layer (PHY) block 116.

The host 101 may comprise suitable logic, circuitry, and/or code that may enable performing user applications that may require network connections. For example, the host 101 may be an application server, a web server, and/or an email server. The host 101 may enable at least one user application to execute in at least one processor. The host 101 may also enable TCP processing or protocol offloading of TCP sessions or connections that may be associated with user applications. In this regard, the host 101 may select one of the TCP connections to be offloaded to the TOE 114 in the NIC 112. For example, the host 101 may offload connections that may be established for long periods of time, such as connections to security or emergency systems. In another example, the host 101 as a result of the overhead that may be required during the connection may process connections that may be set up and terminated quickly. Other criteria may be utilized without departing from the scope of the invention.

The host 101 may also enable the coexistent operation of a native software stack associated with an operating system (OS) executing in at least one of the processors within the host 101 with an offloaded protocol stack associated with software executing in the TOE 114. The offloaded protocol stack may process TCP sessions offloaded to the TOE 114, while the native stack may process those TCP sessions that remain in the host 101. In this regard, the host 101 may enable creation of a communication path between the host 101 and the TOE 114 for TCP offloading. The communication path may be referred to as a plumbing channel between a host endpoint and an offload endpoint, that is, a channel between the native stack and the offloaded protocol stack. The host 101 may enable extending the capabilities of operating systems, such a Linux and/or Windows OS, for example, to enable creation of plumbing channels for TCP offloading operations that remain transparent to user applications.

The CPUs 106a and 106b in the host 101 may comprise suitable logic, circuitry, and/or code that may be enabled for processing user applications, networking connections, and/or other operations, such as management and/or maintenance operations, for example. While FIG. 1 shows two CPUs, the invention need not be so limited and fewer or more CPUs may be utilized. The CPUs 106a and 106b may be communicatively coupled to a north bridge 102. The north bridge 102 may comprise suitable logic, circuitry, and/or code that may be enabled to provide memory-controlling operations. That is, the north bridge 102 may operate as a memory controller for the memory 108. The north bridge 102 may communicate with the NIC 112 via a PCI-X or PCI-Express interface 105, for example.

The south bridge 104 may be communicatively connected to the north bridge 102. The south bridge 104 may comprise suitable logic, circuitry, and/or code that may enable I/O expansion by allowing the I/O peripherals 110 to communicate with the north bridge 104. The I/O peripherals 110 may comprise suitable logic, circuitry, and/or code that may enable introducing information and/or commands to the host 101 and/or receiving and/or displaying information from the host 101.

The NIC 112 may comprise suitable logic, circuitry, and/or code that may enable performing networking processing operations. The NIC 112 may be communicatively coupled to the host 101. In some instances, the host 101 may be communicatively coupled to more than one NIC 112. Similarly, the NIC 112 may be communicatively coupled to more than one host 101. The TOE 114 in the NIC 112 may comprise suitable logic, circuitry, and/or code to perform network-processing operations offloaded from the host 101. In this regard, the TOE 114 may perform network-processing operations for at least one TCP connection offloaded from the host 101. The GbE MAC/PHY block 116 in the TOE 114 may comprise suitable logic, circuitry, and/or code to perform OSI layer 2 and layer 1 operations for communicating information in a TCP connection. While the GbE MAC/PHY block 116 is shown to support 1 Gigabit-per-second (Gbps) communication rate and/or 10 Gbps communication rate, it need not be so limited and may support a plurality of communication rates such as 10 Megabits-per-second (Mbps) and/or 100 Mbps, for example.

In operation, a user application, such as a web server application, for example, may require that a connection be established with a remote device in the network. The host 101 may establish the connection and may determine whether the connection is to be handled by the TOE 112. When the TOE 112 is to handle the network connection, the host 101 may offload the connection to the TOE 112. In some instances, the TOE 112 may be utilized to establish the connection when the host 101 is aware that the connection to be established is to be handled by the TOE 112. The TOE 112 may handle the TCP-related networking operations during the time the TCP connection is offloaded. In some instances, the host 101 may migrate the TCP connection back to the host 101 for handling TCP-related networking operations. When the connection is to be terminated, either the TOE 112 or the host 101 may handle the connection termination.

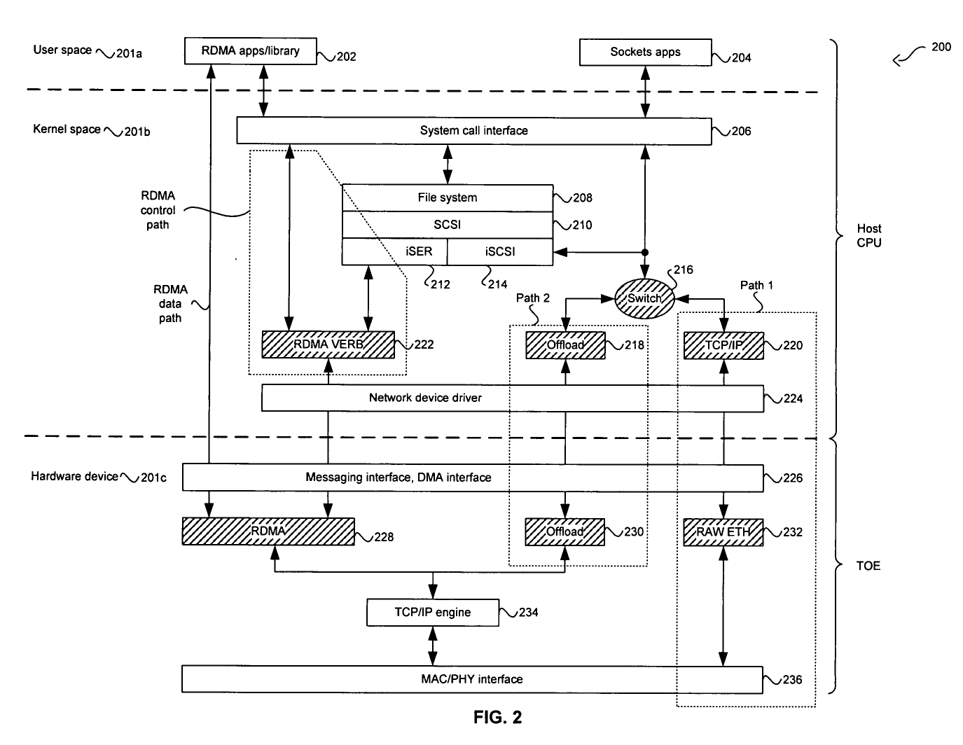

FIG. 2 is a block diagram of an exemplary software architecture that may be utilized for network protocol offloading, in accordance with an embodiment of the invention. Referring to FIG. 2, there is shown a software architecture 200 that may comprise a first portion 201a for user level space operations, a second portion 201b for kernel space operations, and a third portion 201c for hardware device space operations. The user level space 201a and the kernel space 201b may operate in a host CPU, such as the CPUs 106a and 106b in FIG. 1, for example. The hardware device space 201c may correspond to a TOE, such as the TOE 114 in FIG. 1, for example.

At the user level space 201a, there are shown user applications such as remote direct access memory (RDMA) applications and library (apps/lib) 202 and sockets applications 204, for example. At the kernel space level 201b, there are shown a plurality of software modules such as a system call interface module 206, a file system module 208, a small computer system interface (SCSI) module 210, an Internet SCSI (iSCSI) module 214, an iSCSI extension to RDMA (iSER) module 212, an RDMA VERB module 222, a switch module 216, an offload module 218, a TCP/IP module 220, and a network device driver module 224, for example. At the hardware device space 201c, there are shown a plurality of software modules such as a messaging interface and DMA interface module 226, an RDMA module 228, an offload module 230, a raw sockets Ethernet (RAW ETH) module 232, a TCP/IP engine module 234, and a MAC/PHY interface module 236, for example.

The modules in the kernel space 201b and in the hardware device space 201c that are shown with hash lines correspond to extensions in the system architecture that may enable creation of a communication path between the host 101 and the TOE 114 for TCP offloading. The communication path may be referred to as a plumbing channel between a host endpoint and an offload endpoint, that is, a channel between the native stack and the offloaded protocol stack. The switch 216, for example, may be utilized to intercept a system call for a TCP operation. The switch 216 may determine, based on information in the system call, whether the particular TCP session or connection has been offloaded to the TOE 114 or has not been offloaded to the TOE 114. When the TCP session has not been offloaded to the TOE 114, communication between the host CPU and the TOE may occur via the TCP/IP module 220 in the host CPU and the RAW ETH module 232 in the TOE. The path comprising the TCP/IP module 220 and the RAW ETH module 232 may be referred to as path 1. The MAC/PHY interface module 236 may enable communication between the TOE and the network when path 1 is selected via the switch 216.

When the TCP session has been offloaded to the TOE 114, communication between the host CPU and the TOE may occur via the offload module 218 in the host CPU and the offload module 230 in the TOE. The path or channel comprising the offload module 218 and the offload module 230 may be referred to as path 2. Path 2 may also be referred to as a plumbing channel, for example. In this regard, the offload module 218 may correspond to the host endpoint and the offload module 230 may correspond to the offload endpoint of the plumbing channel. The TCP/IP engine 234 and the MAC/PHY interface module 236 may enable communication between the TOE and the network when path 2 or plumbing channel is selected via the switch 216.

When TCP offload support in provided in the software architecture, as in the software architecture 200, for example, RDMA capabilities may also be provided on top of the offloading capabilities. For example, RDMA VERB module 222 may provide a management layer of software that enables controlling the hardware for RDMA operations. In this regard, the communication between the RDMA VERB module 222 and the system call interface module 206 and the iSER module 212 may be referred to an RDMA control path for the software architecture 200. An RDMA data path may be established based on the RDMA control operations between the RDMA apps/lib 202 in the user level space 201a and the RDMA module 228 in the hardware device space 201c, for example.

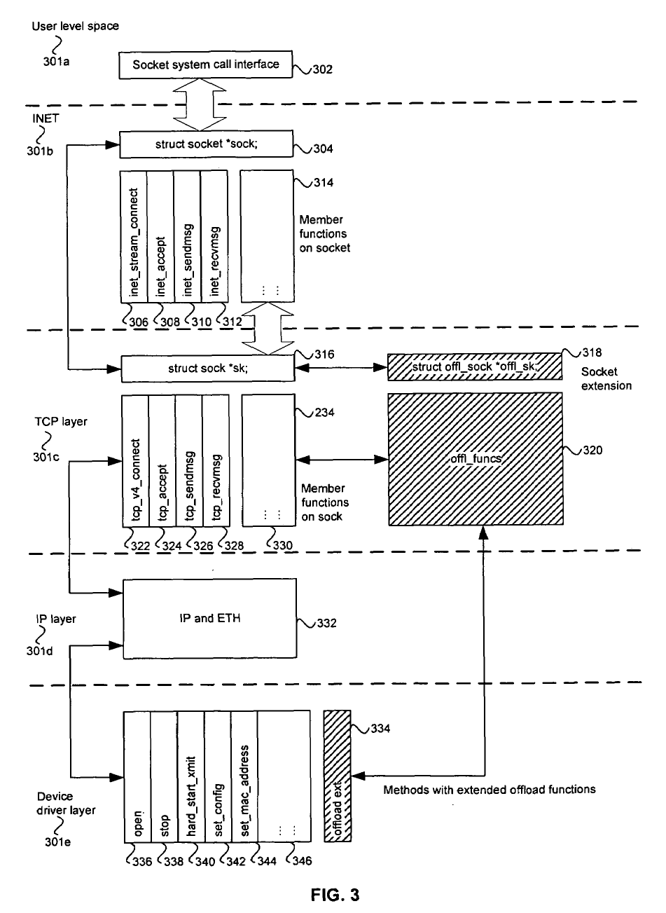

FIG. 3 is a block diagram illustrating exemplary Unix/Linux native stack extension in the kernel space in FIG. 2 for network protocol offloading, in accordance with an embodiment of the invention. Referring to FIG. 3, there is shown an extension to the native stack that corresponds to the operations of the switch 216, the offload module 218, and/or the TCP/IP module 220 in FIG. 2. Blocks in FIG. 3 with a solid white background correspond to native stack data structures in Unix/Linux, while blocks with hashed lines correspond to new data structures the extend the native stack to enable plumbing channels for offloading TCP connections to the TOE 114.

At the user level space 301a, a socket system call interface 302 may communicate with a socket data structure (sock) 304 at the INET level 301b. The INET level 301b may correspond to an Internet address family that supports communication via TCP/IP. The sock 304 may comprise a plurality of member functions such as inet_stream_connect 306, inet_accept 308, inet_sendmsg 310, inet_recvmsg 312, and additional member functions 314, for example. An application may call sock 304 via the socket system call interface 302 when trying to open a new TCP connection. The application may then call a member function associated with sock 304, such as inet_stream_connect 306, for example.

The sock 304 data structure may be utilized to call on and communicate with the sock data structure (sk) 316 at the TCP layer 301c. The sk 316 may comprise a plurality of member functions such as tcp_v4_connect 322, tcp_accept 324, tcp_sendmsg 326, tcp_recvmsg 328, and additional member functions 330, for example. An additional data structure, such as offload socket (offl_sk) 318, may be attached to sk 316 for extending the capabilities of sk 316 to enable channel plumbing. The sk 316 may comprise at least one flag that may indicate if a TCP connection is offloaded. Associated with offl_sk 318 may be a plurality of offload functions (offl_funcs) 320. The offload functions 320 may enable bypassing the TCP, the IP and Ethernet operations 332 in the TCP layer 301c, in the IP layer 301c to the device driver layer 301e when the offload session flag in the sk 316 is set. The device driver layer 301e may comprise a plurality of functions such as open 336, stop 338, hard_start_xmit 340, set_config 342, set_mac_address 344, and additional functions 346, for example. Offload extensions 334 to the device driver layer 301e may enable the network device driver to provide TCP offloading and kernel bypass operations. When the offload session flag in the sk 316 is not set, a direct connection between the TCP layer 301c and the IP layer 301d may take place. Notwithstanding the embodiment of the extensions to the native stack described in FIG. 3, the invention need not be so limited and other embodiments may be utilized.

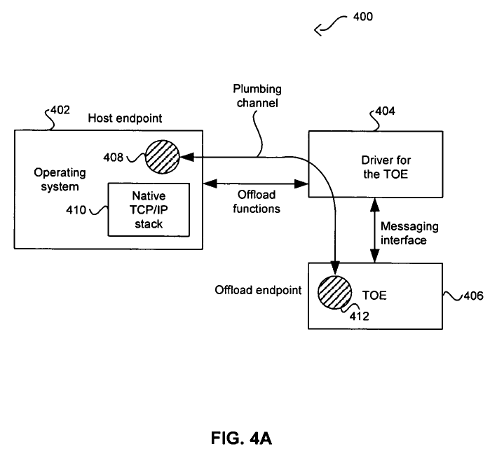

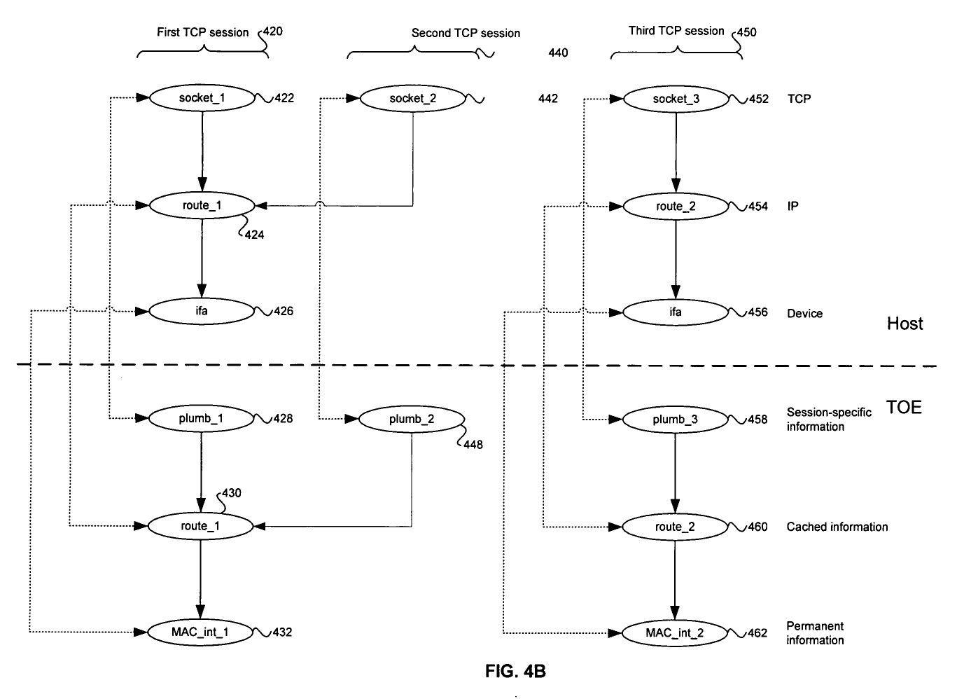

FIG. 4A is a block diagram illustrating exemplary offloading of a TCP session by creating a plumbing channel or path via endpoint association, in accordance with an embodiment of the invention. Referring to FIG. 4A, there is shown a system 400 with an established plumbing channel between an operating system 402 and a TOE 406 via a TOE device driver 404 by endpoint association. In this regard, the operating system 402 may correspond to the host endpoint of the plumbing channel and the TOE 406 may correspond to the offload endpoint of the plumbing channel.

The operating system 402 may comprise a native TCP/IP stack 410 and a data structure 408 associated with the offloaded TCP connection. The data structure 408 may be a host socket, for example. The data structure 408 may enable data to flow between the application in the host system and the TOE 406, which bypasses the kernel level. Communication between the operating system 402 and the TOE device driver 404 may occur via offload functions, such as the offload functions 320 in FIG. 3 associated with the sock data structure, sk 316.

The TOE device driver 404 may communicate with the TOE 406 via a messaging interface, such as the messaging interface and DMA interface 226 in the hardware device level 201c in FIG. 2. The TOE 406 may comprise an offloaded data structure 412 associated with the offloaded TCP connection. The offloaded data structure 412 may be an offloaded socket, for example.

FIG. 4B is a block diagram illustrating exemplary endpoint association of multiple TCP sessions, in accordance with an embodiment of the invention. Referring to FIG. 4B, there are shown various different exemplary TCP sessions that illustrate endpoint association: a first TCP session or connection 420, a second TCP session 440, and a third TCP session 450.

On the host side of the endpoint association, the first TCP session 420 may comprise a socket_1 422 corresponding to the TCP layer, a route_1 424 corresponding to the IP layer, an interface data structure (ifa) 436 corresponding to the TOE device driver. The ifa 436 may correspond to the Ethernet interface for data communication, for example. On the offloaded side of the endpoint association, the first TCP session 420 may comprise a plumbing channel 1 (plumb_1) 428 corresponding to session-specific information, a route_1 430 corresponding to cached information, and a MAC interface 1 (MAC_int_1) 432 corresponding to permanent communication information. The socket_1 422 in the host may be associated with the plumb_1 428 in the TOE. Similarly, routing information in route_1 424 in the host may be associated with routing information in route_1 430 in the TOE. Moreover, the ifa 426 in the host may be associated with the MAC_int_1 432 in the TOE.

The second TCP session 440 may comprise, on the host side of the endpoint association, a socket_2 422 corresponding to the TCP layer, and on the offloaded side of the endpoint association, a plumb_2 448 corresponding to session-specific information. The second TCP session 440 may utilize the same routing and interfacing capabilities, that is, route_1 430 and MAC_int_1 432 assocaited with route_1 424 and ifa 426, respectively, that the first TCP session 420 utilizes, even when different sockets and plumbing channel exists for each of the TCP sessions.

The third TCP session 450, on the host side of the endpoint association, may comprise a socket_3 442 corresponding to the TCP layer, a route_2 454 corresponding to the IP layer, an ifa 456 corresponding to the TOE device driver. On the offloaded side of the endpoint association, the third TCP session 450 may comprise a plumbing channel 3 (plumb_3) 458 corresponding to session-specific information, a route_2 460 corresponding to cached information, and a MAC interface 2 (MAC_int_2) 462 corresponding to permanent communication information. The socket_2 452 in the host may be associated with the plumb_3 458 in the TOE. Similarly, routing information in route_2 454 in the host may be associated with routing information in route_2 460 in the TOE. Moreover, the ifa 456 in the host may be associated with the MAC_int_2 452 in the TOE.

In operation, when data is transmitted from a particular TCP session, the data may flow and/or utilize information from the various components illustrated in FIG. 4B for the endpoint association for that particular TCP session. For example, data from the second TCP session 440 may be communicated to the TOE via the plumb_2 448 and may be communicated from the TOE based on information and/or resources provided by the route_1 424, the ifa_426, the route_1 430, and/or the MAC_int_1. When data is received, the TOE may determine the corresponding TCP session for the data and may communicate the data to the appropriate socket in the TCP layer. For example, when data that is received corresponds to the second TCP session 440, the TOE may communicate the data to the socket_2 442 via the plumb_2 448.

Notwithstanding the exemplary endpoint associations for TCP offloading illustrated in FIG. 4B, the invention need not be so limited and other embodiments may also be utilized.

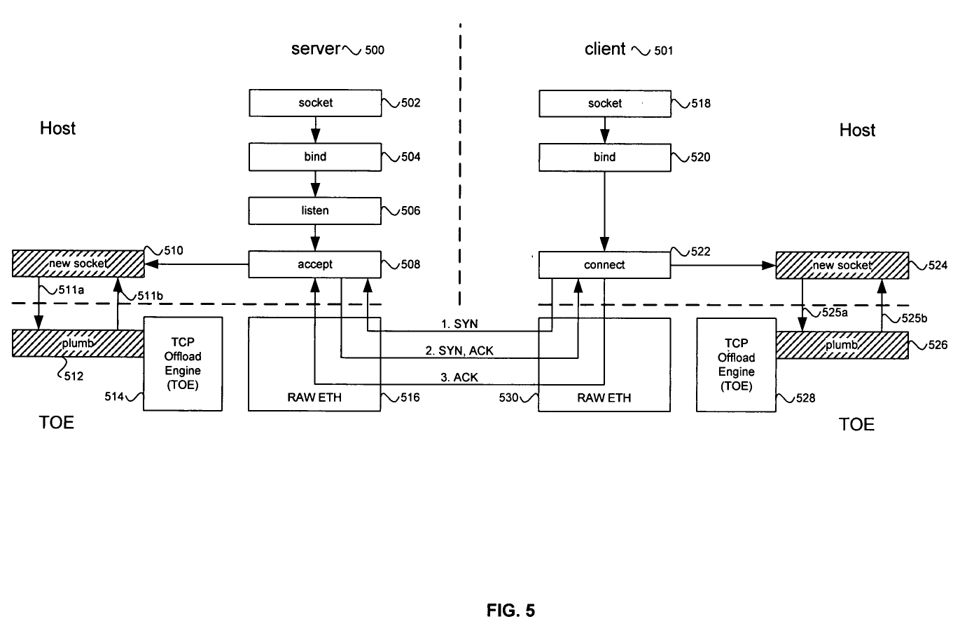

FIG. 5 is a block diagram illustrating exemplary opening of a TCP connection via the native stack, in accordance with an embodiment of the invention. Referring to FIG. 5, there are shown operations that may occur in a server 500 and in a client 501 for the opening or creating a TCP connection via the native stack before offloading the TCP connection. Blocks in solid white background may correspond to conventional operations that may occur in creating a TCP connection while blocks with hashed lines corresponds to additional operations that may enable channel plumbing for TCP offloading. In this regard, an application running on the server 500 may call a socket 502 to locate a data structure for the TCP connection. After the socket 502 is called, a binding operation, bind 504, may be called that may allow assigning or binding an IP address and a port number of the connection to the socket 502. After the bind 504 is called, a listening operation, listen 506, may be called as an open loop to wait until a client sends a request that they may want to open a connection.

On the client 501 side, an application may call a socket 518 which may call a binding operation, bind 520, which may be utilized to get the local IP address and port number. After bind 520, a connect operation 522 may be called to initialize a handshake process to create or establish a TCP connection with the server 500. Both the server 500 and the client 501 may utilize their respective native stacks to handle the opening process. For example, the client 501 may communicate a request signal, SYN, via the RAW ETH 530 from the connect operation 522 to start the opening process. The server 500 may be listening until it receives the SYN signal via the RAW ETH 516 and may call an accept operation 508 to handle the opening process. The RAW ETH 530 and the RAW ETH 516 may be the same or substantially similar to the RAW ETH 232 illustrated in FIG. 2, for example. The accept operation 508 may communicate an acknowledgment, ACK, and its own request for synchronization, SYN, to the connect operation 522 in the client 501. The client 501 may respond by sending an acknowledgment, ACK, from the connect operation 522 to the accept operation 508. After successfully completing the handshake process, the TCP session or connection between the server 500 and the client 501 has been established.

After the TCP connection has been established, the server 500 may determine that the TCP connection is to be offloaded to the TOE 514. In this regard, the accept operation 508 in the server 500 may spawn a new socket 510. The new socket 510 may generate a message or signal 511a, such as MSG_TCP_CREATE_PLUMB, for example, to the TOE 514 to create a TCP plumbing channel. The message 511a may comprise information regarding the address of the new socket 510. The TOE 514 may respond by generating a message or signal 511b, such as TCP_PLUMB_RSP, for example, to the new socket 510 with the address of the plumbing channel 512. Once the endpoint association is established between the new socket 510 and an offloaded socket in the TOE 514 via the plumbing channel 512, the TCP connection with the client 501 may be offloaded to the TOE 514.

Similarly, after the TCP connection has been established, the client 501 may determine that the TCP connection is to be offloaded to the TOE 528. In this regard, the connect operation 522 in the client 501 may spawn a new socket 524. The new socket 524 may generate a message or signal 525a, such as MSG_TCP_CREATE_PLUMB, for example, to the TOE 528 to create a TCP plumbing channel. The message 525a may comprise information regarding the address of the new socket 524. The TOE 528 may respond by generating a message or signal 525b, such as TCP_PLUMB_RSP, for example, to the new socket 524 with the address of the plumbing channel 526. Once the endpoint association is established between the new socket 524 and an offloaded socket in the TOE 528 via the plumbing channel 526, the TCP connection with the server 500 may be offloaded to the TOE 528.

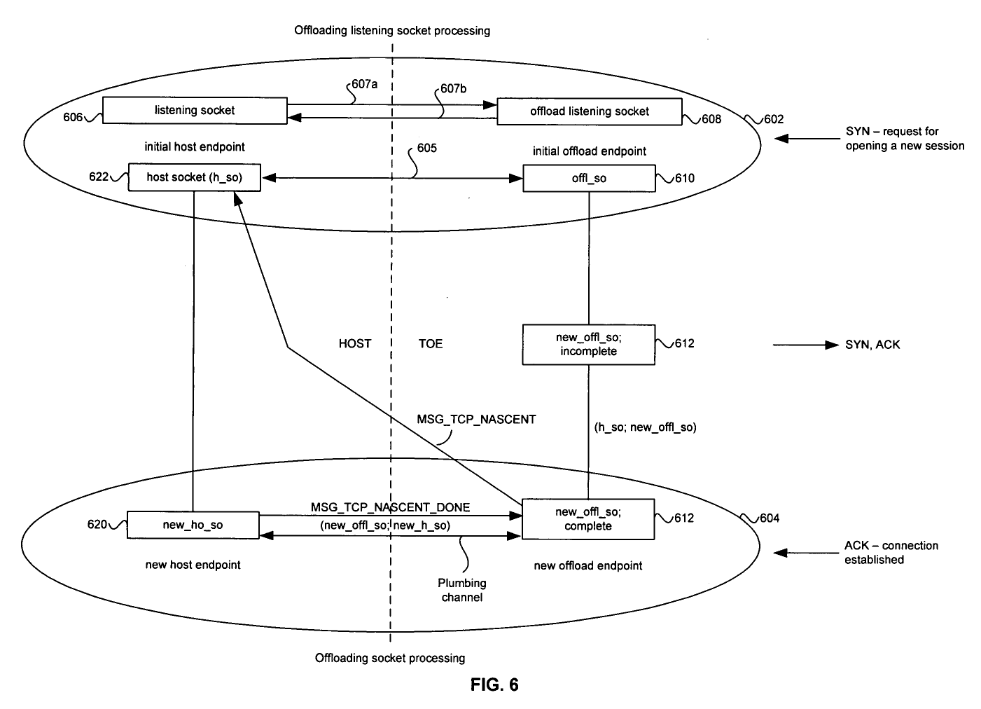

FIG. 6 is a block diagram illustrating an exemplary offloading of a listening socket, in accordance with an embodiment of the invention. Referring to FIG. 6, there are shown offloading listening socket operations 602 associated with the listening operation that occurs during the opening of a TCP connection and offloading socket processing operations 604 associated with the offloading of the TCP connection once established.

Regarding the offloading listening socket operations 602, before a TCP connection is established, a host socket (h_so) 622 and a listening socket 606 may be called by a host. The host socket 622 may correspond to an initial host endpoint for TCP offloading endpoint association. A plumbing channel 605 may be created between the host socket 622 and an offload socket (offl_so) 610 in the TOE. The offload socket 610 may correspond to an initial offload endpoint for TCP offloading endpoint association. The listening socket 606 may be utilized for listening to requests that may be sent by a client for opening a TCP connection. The listening socket 606 may send a message or signal 607a with the address of the listening socket 606 to the peer TOE to create a plumbing channel to enable offloading the listening operation to the TOE. The TOE may send a message or signal 607b back to the listening socket 606 in the host with the plumbing channel address. Once the plumbing channel is established, the listening operation may be offloaded to an offloaded listening socket 608.

The offloaded listening socket 608 may be utilized to open a TCP connection via a handshake process. When a request, SYN, is received from a client, the offloaded listening socket 608 may create a new offloaded socket (new_offl_so) 612 in the TOE and may also generate an acknowledgment, ACK, and its own synchronization request, SYN, back to the client. The new_offl_so 612 may be incomplete. When the client responds by sending its acknowledgement, ACK, the new_offl_so 612 may be completed and may comprise information regarding its own address and the address of the host socket 622. The new_offl_so_612 may correspond to a new offload endpoint for TCP offloading end[point association.

The new_offl_so 612 may be part of the offloading socket processing operations 604 associated with the offloading of the TCP connection. After the connection is established and the new_offl_so 612 is completed, the TOE may issue a message or signal to the host, such as MSG_TCP_NASCENT, for example, to indicate that the TCP connection has been established. The host may allocate a new host socket (new_ho_so) 620 as a result of the MSG_TCP_NASCENT message and may issue or send a message, such as a MSG_TCP_NASCENT_DONE, for example, to indicate to the TOE that the new host socket 620 has been allocated. The new host socket 620 may correspond to a new host endpoint for TCP offloading endpoint association. The message MSG_TCP_NASCENT_DONE may comprise information regarding the address of the new host socket 620 and of the new offloaded socket 612 to establish a plumbing channel that enables TCP offloading. Notwithstanding the processes or operations illustrated in FIG. 6, the invention need not be so limited and other embodiments of the offloading of the listening operation and of the TCP connection may be utilized.

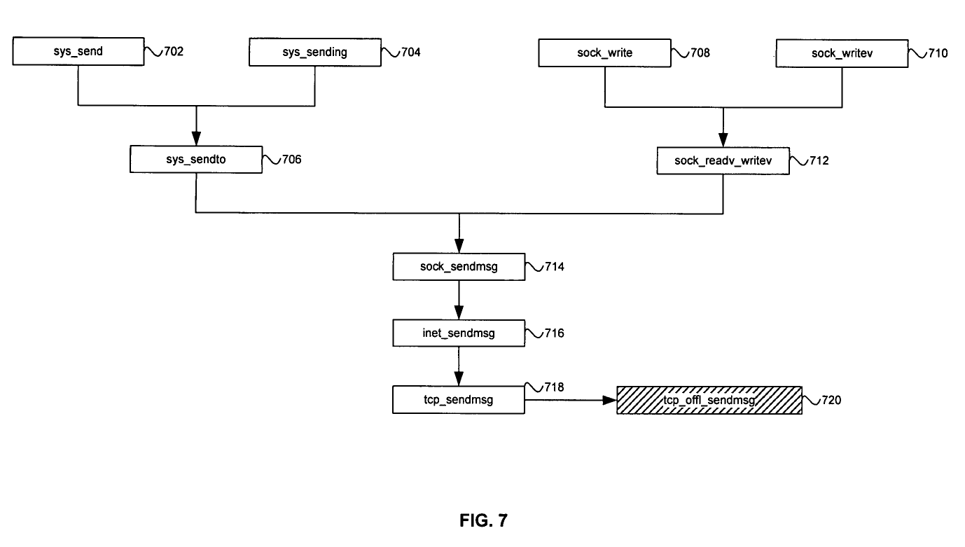

FIG. 7 is a block diagram illustrating exemplary hooks on the native stack for packet send offload, in accordance with an embodiment of the invention. Referring to FIG. 7, there is shown a plurality of system calls that may be utilized by the native stack to send packets from a server, for example. Blocks with the white solid background correspond to conventional system calls while blocks with the hashed lines correspond to extension functions that may be attached to the native stack for bypassing the native stack and for supporting offloading. The conventional system calls may comprise a sys_send 702, a sys_sending 704, a sys_sendto 706, a sock_write 708, a sock_writev 710, a sock_readv_writev 712, a sock_sendmsg 714, an inet_sendmsg 716, and a tcp_sendmsg 718. An extension function, TCP offload send message (tcp_offl_sendmsg) 720 may be utilized for enabling bypassing the native stack and for supporting TCP offloading when a flag indicating TCP offloading is set in, for example, the offload socket 318 that may be attached to sock 316 in FIG. 3.

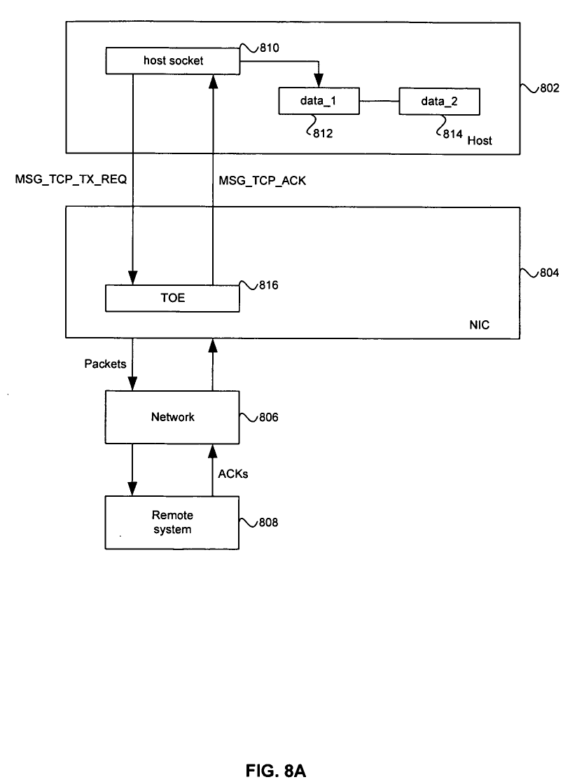

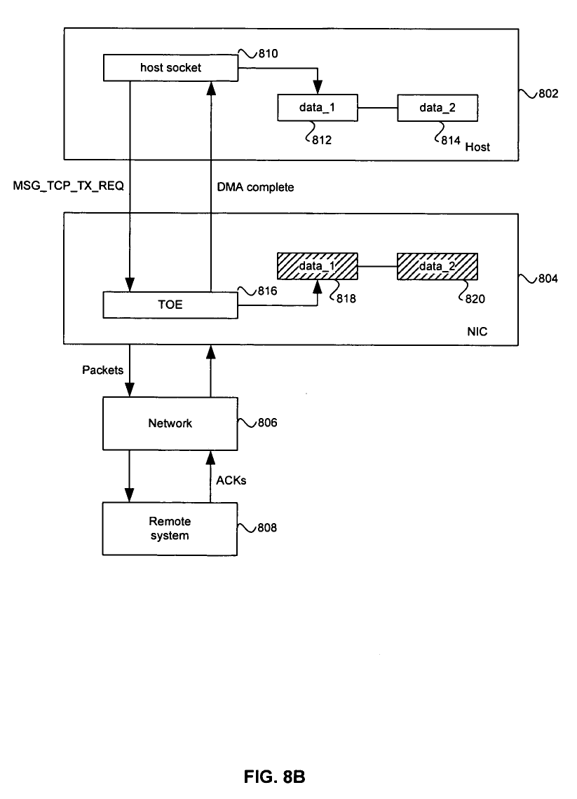

FIG. 8A is a block diagram illustrating an exemplary system where the host handles retransmission by maintaining transmitted data in the host socket send queue, in accordance with an embodiment of the invention. Referring to FIG. 8A, there are shown a host 802, a NIC 804, a network 806, and a remote system or client 808. The host 802 and the NIC 804 may be the same or substantially similar to the host 101 and the NIC 112 in FIG. 1, respectively. The host 802 and the NIC 804 may support TCP offloading by creating plumbing channels via endpoint association. The host 802 may comprise a host socket 810, a data_1 812 and a data_2 814. The host socket 810 may correspond to a host endpoint of a plumbing channel for a TCP connection. The data_1 812 and the data _2 814 may correspond to transmitted data locations in the send queue of the host socket 802 that may be utilized for retransmission operations. In another embodiment of the invention, fewer or more transmitted data locations may be utilized. The contents associated with data_1 812 and data_2 814 may be stored in memory such as memory 108 in FIG. 1, for example. The NIC 804 may comprise a TOE 816 that may correspond to the offload endpoint of plumbing channel established with the host socket 810.

The network 806 may comprise suitable logic, circuitry, and/or code that may enable communication between the remote system 808 and the host 802 via the NIC 804. The remote system 808 may comprise suitable logic, circuitry, and/or code that may enable establishing a communication link for exchanging data with the host 802 via the network 806 and the NIC 804.

During transmission operation, the host socket 810 may send a message or signal, such as MSG_TCP_TX_REQ, to the TOE 816 to request that a packet of data from data_1 812 and/or data _2 814 be transmitted to the remote system 808 via the network 806. After the request is received, the data packet may be direct memory accessed (DMA) by the TOE 816 from the host 802. The TOE 802 may frame the data packet and may transmit the framed data packet to the remote system 808 via the network 806. When the remote system 808 receives the framed data packet, it may generate an acknowledgment message, ACK, that may be communicated to the to the TOE 816 via the network 806. After receiving the ACK message the TOE 816 may generate a message or signal to the host socket 810 via the plumbing channel to release the transmitted data from the send queue for retransmission purposes.

FIG. 8B is a block diagram illustrating an exemplary system where the TOE handles retransmission by maintaining transmitted data in the offload socket send queue until the data is acknowledged, in accordance with an embodiment of the invention. Referring to FIG. 8B, there are shown the host 802, the NIC 804, the network 806, and the remote system 808 from FIG. 8A, where the NIC 804 may comprise local copies, data_1 818 and data_2 820, of the data_1 812 and the data_2 814 transmitted data locations in the send queue of the host socket 802. The local copies data_1 818 and data_2 820 are shown in blocks with hashed lines and may be DMA from the host 802 onto the NIC 804.

During transmission operation, the host socket 810 may send a message or signal, such as MSG_TCP_TX_REQ, to the TOE 816 to request that a packet of data from data_1 812 and/or data _2 814 be transmitted to the remote system 808 via the network 806. After the request is received, the data packet may be DMA by the TOE 816 from the host 802 and may be stored in the local copies data_1 818 and data_2 820. After the transfer is completed, the TOE 816 may generate a message or signal to the host 802 to indicate that the DMA transfer has been completed. The host 802 may release the transmitted data from the send queue for retransmission purposes. The TOE 802 may frame the data packet from the local copies and may transmit the framed data packet to the remote system 808 via the network 806. When the remote system 808 receives the framed data packet, it may generate an acknowledgment message, ACK, that may be communicated to the TOE 816 via the network 806. After receiving the ACK message the TOE 816 release the transmitted data from the offload send queue for retransmission purposes.

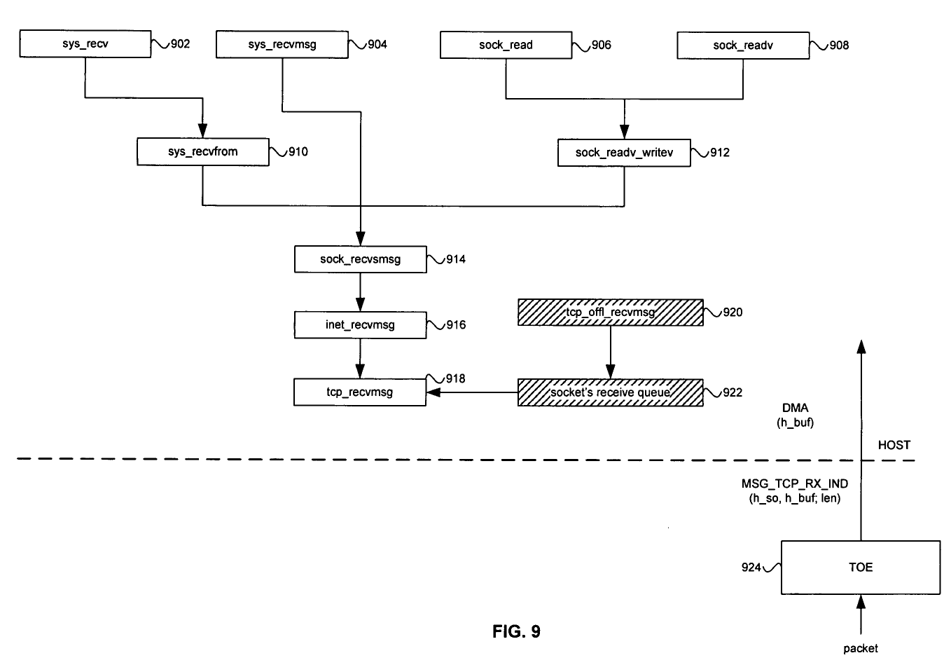

FIG. 9 is a block diagram illustrating exemplary hooks on the native stack for packet receive, in accordance with an embodiment of the invention. Referring to FIG. 9, there is shown a plurality of system calls that may be utilized by the native stack in the host to receive packets from a client, for example. Blocks with the white solid background correspond to conventional system calls while blocks with the hashed lines correspond to extension functions that may be attached to the native stack for bypassing the native stack and for supporting offloading. The conventional system calls may comprise a sys_recv 902, a sys_recvmsg 904, a sys_recvfrom 910, a sock_read 906, a sock_readv 908, a sock_readv_writev 912, a sock_recvmsg 914, an inet_recvmsg 916, and a tcp_recvmsg 918. Extension functions, TCP offload receive message (tcp_offl_recvmsg) 920 and socket's receive queue 922 may be utilized for enabling bypassing the native stack and for supporting TCP offloading when a flag indicating TCP offloading is set in, for example, the offload socket 318 that may be attached to sock 316 in FIG. 3.

In operation, the TOE 924 shown in FIG. 9 may receive a packet. The received packet may be DMA transferred to a host buffer (h_buf). After the DMA transfer operation, the TOE 924 may generate a message or signal, such as MSG_TCP_RX_IND, to the device driver associated with the host socket (h_so) to indicate to the host socket that a TCP packet has been received. The message to the host socket may indicate to which host buffer the packet was sent and the length of the packet (len). The device driver may then call tcp_offl_recvmsg 920 which may place the received packet in the socket receive queue 922.

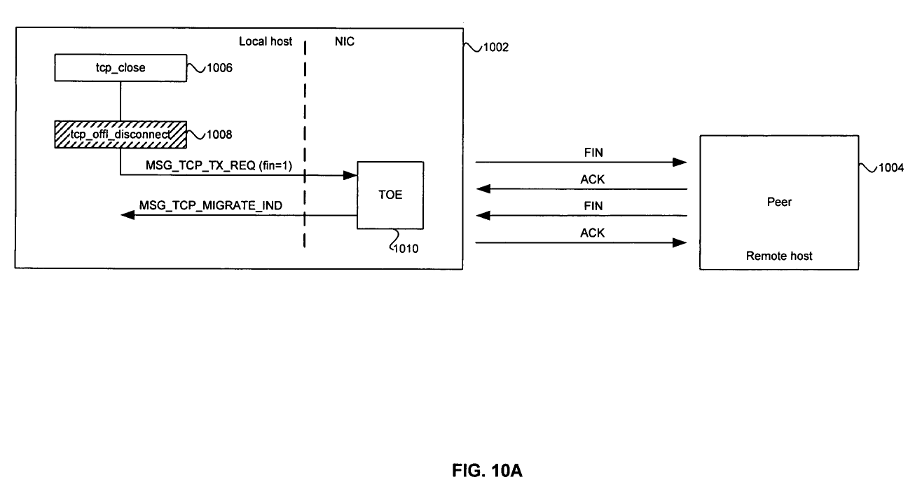

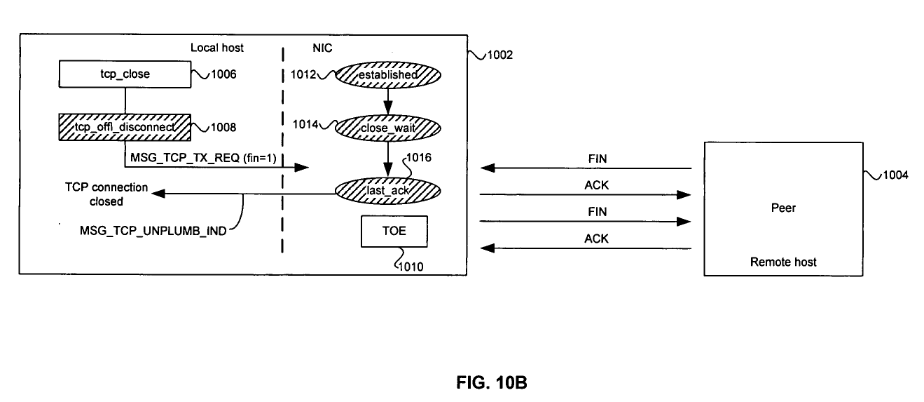

FIG. 10A is a block diagram illustrating exemplary active close connection termination, in accordance with an embodiment of the invention. Referring to FIG. 10A, there are shown a local server 1002 and a remote client or peer 1004. The local server 1002 may comprise a local host portion and a NIC portion. The local host portion and the NIC portion may be the same or substantially similar to the host 101 and the NIC 112 in FIG. 1, respectively. The local host portion may correspond to the host endpoint of a plumbing channel utilized for offloading a current TCP connection with the peer 1004. The NIC portion may comprise a TOE 1010 that may correspond to the offload endpoint of the plumbing channel. The tcp_close 1006 may be a conventional system call for terminating a TCP connection supported by the native stack in the operating system executing on the local host portion of the local server 1002. The TCP offload disconnect (tcp_offl_disconnect) 1008 may be an extension function to the native stack that may enable terminating an offloaded TCP connection.

During an active closing operation, the local server 1002 may initiate closing or termination of the TCP connection. In this regard, the tcp_offl_disconnect 1008 may generate a message or signal, such as MSG_TCP_TX_REQ, for example, to the TOE 1010. The message may have a flag set, such as fin=1, for example, to indicate to the TOE 1010 that the TCP connection with the peer 1004 may be finished or terminated. In active closing, the TOE 1010 may generate a message or signal, such as FIN, for example, to the peer 1004 requesting to terminate or close the TCP connection. The peer 1004 may acknowledge the request with an ACK signal to the TOE 1010. The peer 1004 may also send a FIN message requesting termination of the TCP connection to the TOE 1010. The TOE 1010 may acknowledge receipt of the request with an ACK signal to the peer 1004. After sending the ACK signal to the peer 1004, the TOE 1010 may generate a message or signal, such as MSG_TCP_MIGRATE_IND, for example, to the host socket to have the TCP session or connection migrated to the local host portion of the local server 1002. In this regard, migrating the TCP connection to the host for further processing and termination may enable the native stack in the local host to handle TIME_WAIT state information associated with the TCP connection to be terminated. The local host may then wait for some period of time, for example, approximately sixty (60) seconds, and may clean up all the data structures on the TIME_WAIT state related to the closed TCP connection.

FIG. 10B is a block diagram illustrating exemplary passive close connection termination, in accordance with an embodiment of the invention. Referring to FIG. 10B, there are shown the local server 1002 and the remote client or peer 1004 of FIG. 10A. During a passive closing operation, the peer 1004 may initiate closing or termination of the TCP connection. On the local server 1002 side, for example, the tcp_offl_disconnect 1008 may have generated a message or signal, such as MSG_TCP_TX_REQ, for example, to the TOE 1010. The message may have a flag set, such as fin=1, for example, to indicate to the TOE 1010 that the TCP connection with the peer 1004 may be finished or terminated.

In passive closing, the peer 1004 may generate a message or signal, such as FIN, for example, to the TOE 1010 requesting to terminate or close the TCP connection. The TOE 1010 may acknowledge the request with an ACK signal to the peer 1004. In this regard, the TEO 1010 may change from an established TCP state 1012 to a close_wait TCP state 1014. The established TCP state 1012 indicates that a TCP connection is established while the close_wait TCP state 1014 indicates that the TOE 1010 is waiting for local application to close or terminate the TCP connection. Once the local application calls the function tcp_close, a message MSG_TCP_TX_REQ with the termination flag fin set to 1 may be sent to the TOE 1010 via the offload function tcp_offl_disconnet 1008. The TOE 1010 may send a FIN message requesting termination of the TCP connection to the peer 1004. The TOE 1010 may change from the close_wait TCP state 1014 to the last_ack TCP state 1016, waiting for the peer 1004 to generate an acknowledgment, ACK, to close the connection. The TOE 1010 may handle the closing of the TCP connection with the peer 1004 and may generate a message or signal, such as MSG_TCP_UNPLUMB_IND, for example, to the local host portion of the local server 1002 to indicate that the TCP connection with peer 1004 has been closed.

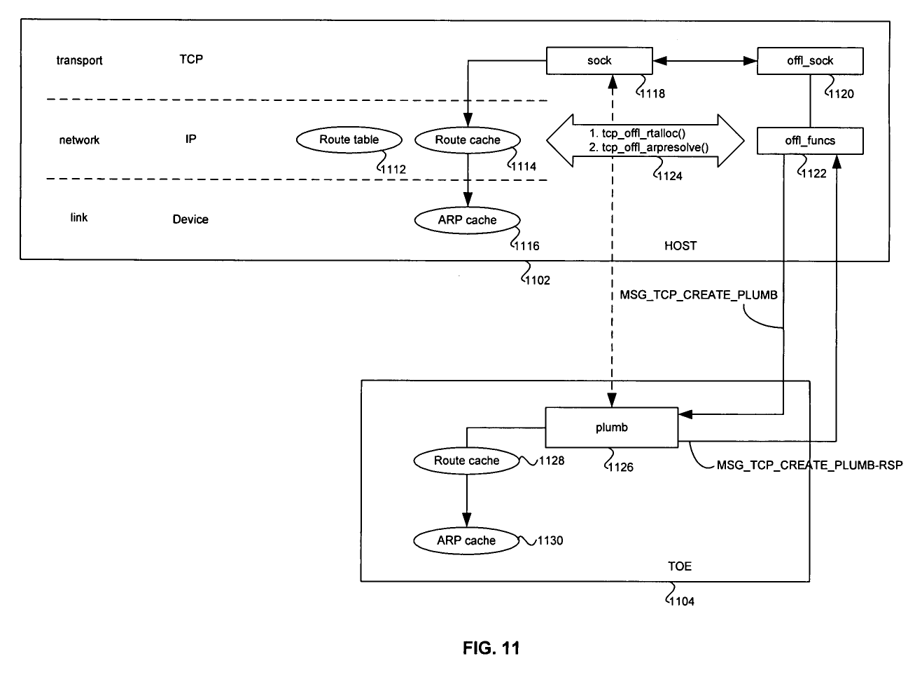

FIG. 11 is a block diagram illustrating exemplary route management and offload of a route, in accordance with an embodiment of the invention. Referring to FIG. 11, there are shown a host 1102 and a TOE 1104 that may be the same or substantially similar to the host 101 and the TOE 114 in FIG. 1, respectively. In this regard, there are shown three OSI layers associated with the host 1102. The transport layer, associated with TCP operations, may comprise a socket data structure (sock) 1118 that may be attached to an offloaded socket data structure (offl_sock) 1120. The offl_sock 1120 may utilized extended functions, such as offload functions (offl_funcs) 1122 to enable offloading TCP connections to the TOE 1104 via a plumbing channel. The network layer in the host 1102, associate with IP operations, may comprise a route table 1112 and a route cache 1114. The route table 1112 may comprise general routing information, such as the network or subnet route, for example. The route cache 1114 may comprise more specific routing information, such as the host route, for example. The link layer in the host 1102, associated with device level operations, may comprise an address resolution protocol (ARP) cache 1116 that may comprise specific IP-to-Ethernet addressing information, for example.

In operation, the offload functions 1122 associated with the offload socket 1120, may be utilized to offload the route cache 1114 and the ARP cache 1116 to the TOE 1104. In this regard, functions such as tcp_offl_rtalloc and tcp_offl_arpresolve, for example, may be utilized to indicate that the route cache 1114 and the ARP cache 1116 are to be offloaded. The offload functions 1122 may be utilized to generate a message or signal, such as MSG_TCP_CREATE_PLUMB, for example, to create a plumbing channel 1126 for offloading to the TOE 1104. The TOE 1104 may respond to the request with a message or signal, such as MSG_TCP_CREATE_PLUMB_RSP, to indicate that the plumbing channel 1126 has been created. Once the plumbing channel exists, the route cache 1114 and the ARP cache 1116 may be offloaded to the TOE 1104 as route cache 1128 and the ARP cache 1130, for example.

The approach described herein may enable offloading protocol processing for selected TCP sessions from host processors to a TCP offload engine in operating systems that do not have a standard manner of supporting protocol offloading by providing extensions to the native stack that generate an offload path or plumbing channel between a host endpoint and an offload endpoint.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for handling TCP connections, the method comprising:
establishing an offload path between a host socket in a host and an offloaded socket in a TOE, wherein offload functions associated with extensions to said host socket enable TCP offload and IP layer bypass extensions in a network device driver for establishing said offload path; and
offloading a TCP connection to said TOE after said offload path is established.

2. The method according to claim 1, further comprising establishing said offload path if at least one flag in said extensions to said host socket indicates that said TCP connection offloading is to occur.

3. The method according to claim 1, further comprising establishing said offload path after said TCP connection is established via a native stack in said host.

4. The method according to claim 1, further comprising establishing a listening path between a listening socket in said host and an offloaded listening socket in said TOE for establishing said TCP connection.

5. The method according to claim 1, further comprising storing data in said host for data retransmission associated with said offloaded TCP connection.

6. The method according to claim 1, further comprising storing data in said TOE for data retransmission associated with said offloaded TCP connection.

7. The method according to claim 1, further comprising terminating said TCP connection in said TOE.

8. The method according to claim 1, further comprising terminating said TCP connection in said host by migrating said offloaded TCP connection from said TOE back to said host.

9. The method according to claim 1, further comprising offloading a route and ARP cache to said TOE via said offload path.

10. A machine-readable storage having stored thereon, a computer program having at least one code section for handling TCP connections, the at least one code section being executable by a machine for causing the machine to perform steps comprising:
establishing an offload path between a host socket in a host and an offloaded socket in a TOE, wherein offload functions associated with extensions to said host socket enable TCP offload and IP layer bypass extensions in a network device driver for establishing said offload path; and
offloading a TCP connection to said TOE after said offload path is established.

11. The machine-readable storage according to claim 10, further comprising code for establishing said offload path if at least one flag in said extensions to said host socket indicates that said TCP connection offloading is to occur.

12. The machine-readable storage according to claim 10, further comprising code for establishing said offload path after said TCP connection is established via a native stack in said host.

13. The machine-readable storage according to claim 10, further comprising code for establishing a listening path between a listening socket in said host and an offloaded listening socket in said TOE for establishing said TCP connection.

14. The machine-readable storage according to claim 10, further comprising code for storing data in said host for data retransmission associated with said offloaded TCP connection.

15. The machine-readable storage according to claim 10, further comprising code for storing data in said TOE for data retransmission associated with said offloaded TCP connection.

16. The machine-readable storage according to claim 10, further comprising code for terminating said TCP connection in said TOE.

17. The machine-readable storage according to claim 10, further comprising code for terminating said TCP connection in said host by migrating said offloaded TCP connection from said TOE back to said host.

18. The machine-readable storage according to claim 10, further comprising code for offloading a route and ARP cache to said TOE via said offload path.

19. A system for handling TCP connections, the system comprising:
at least one processor for establishing an offload path between a host socket in a host and an offloaded socket in a TOE, wherein offload functions associated with extensions to said host socket enable TCP offload and IP layer bypass extensions in a network device driver for establishing said offload path; and
said at least one processor offloads a TCP connection to said TOE after said offload path is established.

20. The system according to claim 19, wherein said at least one processor establishes said offload path if at least one flag in said extensions to said host socket indicates that said TCP connection offloading is to occur.

21. The system according to claim 19, wherein said at least one processor establishes said offload path after said TCP connection is established via a native stack in said host.

22. The system according to claim 19, wherein said at least one processor established a listening path between a listening socket in said host and an offloaded listening socket in said TOE for establishing said TCP connection.

23. The system according to claim 19, wherein said at least one processor stores data in said host for data retransmission associated with said offloaded TCP connection.

24. The system according to claim 19, wherein said at least one processor stores data in said TOE for data retransmission associated with said offloaded TCP connection.

25. The system according to claim 19, wherein said at least one processor terminates said TCP connection in said TOE.

26. The system according to claim 19, wherein said at least one processor terminates said TCP connection in said host by migrating said offloaded TCP connection from said TOE back to said host.

27. The system according to claim 19, wherein said at least one processor offloads a route and ARP cache to said TOE via said offload path.
